(19) United States
(12) Patent Application Publication
(10) Pub. No.: US 2023/0283915 A1
(43) Pub. Date: Sep. 7, 2023

(54) FACILITY FOR USE IN PROVIDING SIMULATED ENVIRONMENT

(71) Applicant: 4GD LIMITED, London (GB)

(72) Inventors: Robert Taylor, London (GB); Claude McCullin, London (GB)

(21) Appl. No.: 17/926,917

(22) PCT Filed: Jun. 7, 2021
(86) PCT No.: PCT/GB2021/051409

§ 371 Date: Nov. 21, 2022

(30) Foreign Application Priority Data
Jun. 12, 2020 (GB) 2008971.0

(51) Int. Cl. H04N 23/90; G06V 20/52; H04N 23/695; E04H 1/00

(52) U.S. Cl. CPC H04N 23/90; E04H 1/00; G06V 20/52; H04N 23/695

(57) ABSTRACT

A facility for use in providing a simulated environment comprises a plurality of walls and a plurality of connectors for interconnecting the walls in at least two different configurations to form at least two rooms, a plurality of cameras, and a support structure configured to support the plurality of cameras above the height of the walls. In this way the cameras may be arranged such that the floor area all of the rooms is visible by the cameras in the different wall configurations. The facility may include one or more functions such as lighting, imagery, explosion, smoke generation, aroma generation, sound, appearance or movement of a target. The functions may be configured, for example via a user interface on a computing device, to be operated from any of control devices, e.g. wall mounted, trigger devices, e.g. hand held, or sensors.

### BACKGROUND

The present invention relates to a facility for use in providing a simulated environment and observing users of the environment. The invention may be used in a variety of applications including but not limited to personnel training and gaming, in many fields including civilian and military. There is a need for this kind of facility to be reconfigurable, for example to enable the environment to be varied from one exercise to another. There is also a need for such reconfiguration to be achieved as quickly and simply as possible.

Some embodiments of the invention described below solve some of these problems. However the invention is not limited to solutions to these problems.

### SUMMARY

This summary is provided to introduce a selection of concepts in a simplified form that are further described below in the detailed description. This summary is not intended to identify key features or essential features of the claimed subject matter, nor is it intended to be used to determine the scope of the claimed subject matter.

In one aspect there is provided in the following a facility for use in providing a simulated environment comprising a plurality of walls and a plurality of connectors for interconnecting the walls in at least two different configurations to form at least two rooms, a plurality of cameras and a support structure configured to support the plurality of cameras above the height of the walls, for example to support an array of cameras all at the same predetermined height above the floor of the facility. In this way the cameras may be arranged such that the floor area all of the rooms is visible by the cameras in the different wall configurations. Further, the camera images may be displayed to provide a composite image on a monitor of a rectangular arrangement of rooms in the same spatial arrangement as they are present on the facility floor. The facility may include one or more functions such as lighting, imagery, explosion, smoke generation, aroma generation, sound, appearance or movement of a target. The functions may be configured, for example via a user interface on a computing device, to be operated from any of control devices e.g. wall mounted, trigger devices e.g. hand held, or sensors.

In one aspect the invention provides a kit of parts for constructing such a facility.

Embodiments of the invention also provide a computer readable medium comprising instructions which when implemented in a computing device enable the computing device to configure one or more functions of the facility.

Features and aspects of embodiments of the invention are described in further detail below.

Features of different aspects and embodiments of the invention may be combined as appropriate, as would be apparent to a skilled person, and may be combined with any of the aspects of the invention.

### BRIEF DESCRIPTION OF THE DRAWINGS

Embodiments of the invention will be described, by way of example only and with reference to the following drawings, in which:

FIG. 1a is a perspective view of an installed facility, according to some embodiments of the invention.

FIG. 1b is a perspective view of a door and door frame that may be incorporated in the facility shown in FIG. 1a, according to some embodiments of the invention.

FIG. 2a is a schematic plan view of an installed facility, according to some embodiments of the invention, showing one room configuration.

FIG. 2b is a schematic plan view of an installed facility, according to some embodiments of the invention, showing a different room configuration from that of FIG. 2a.

FIG. 3a shows the facility of FIG. 2a divided into three zones, according to some embodiment of the invention.

FIG. 3b shows an array of floor panels, according to some embodiments of the invention.

FIG. 4a shows a magnetically mountable switch panel that may be provided in some embodiments.

FIG. 4b is a perspective view of an electronics housing in which a plurality of switch panels may be accommodated, according to some embodiments of the invention.

FIG. 5a is a cut away view of the housing of FIG. 4b housing a portable computing device, according to some embodiments of the invention.

FIG. 5b is a view of a portable computing device, according to some embodiments of the invention.

FIG. 6a shows a view of a room in a facility using all mounted cameras, according to some embodiments of the invention.

FIG. 6b shows a view of a room in a facility using “top down” cameras, according to some embodiments of the invention.

FIG. 7a illustrates the use of PTZ cameras, according to some embodiments of the invention.

FIG. 7b illustrates the use of PTZ cameras, according to some embodiments of the invention.

FIG. 7c illustrates the use of PTZ cameras, according to some embodiments of the invention.

FIG. 8a illustrates the cropping of a panoramic image, according to some embodiments of the invention.

FIG. 8b illustrates the cropping of a panoramic image, according to some embodiments of the invention.

FIG. 8c illustrates the cropping of a panoramic image, according to some embodiments of the invention.

FIG. 8d illustrates the cropping of a panoramic image, according to some embodiments of the invention.

FIG. 8e illustrates the cropping of a panoramic image, according to some embodiments of the invention.

FIG. 9 shows an example of a trigger device that may be provided in a smart facility, according to some embodiments of the invention.

FIG. 10a shows an example of a user interface, according to some embodiments of the invention.

FIG. 10b shows an example of a user interface, according to some embodiments of the invention.

FIG. 10c shows an example of a user interface, according to some embodiments of the invention.

FIG. 11 shows an example of a user interface that might be provided as part of an installation application, according to some embodiments of the invention.

FIG. 12 shows an example of a user interface that might be provided as part of an installation application, according to some embodiments of the invention.

FIG. 13 shows a viewing screen that may be provided, according to some embodiments of the invention.

Common reference numerals are used throughout the figures to indicate similar features.

### DETAILED DESCRIPTION

Embodiments of the present invention are described below by way of example only. These examples represent the best ways of putting the invention into practice that are currently known to the applicant although they are not the only ways in which this could be achieved.

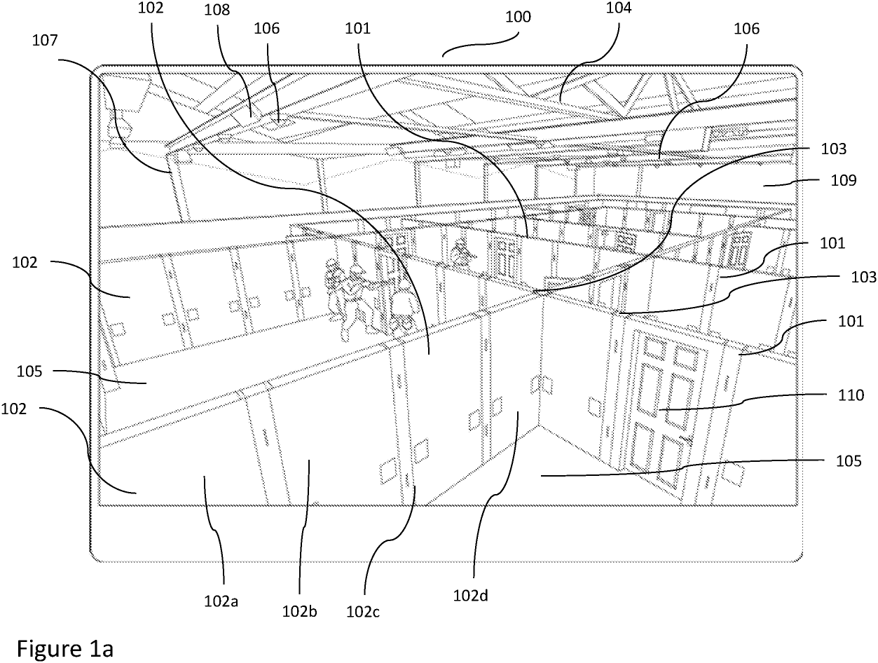

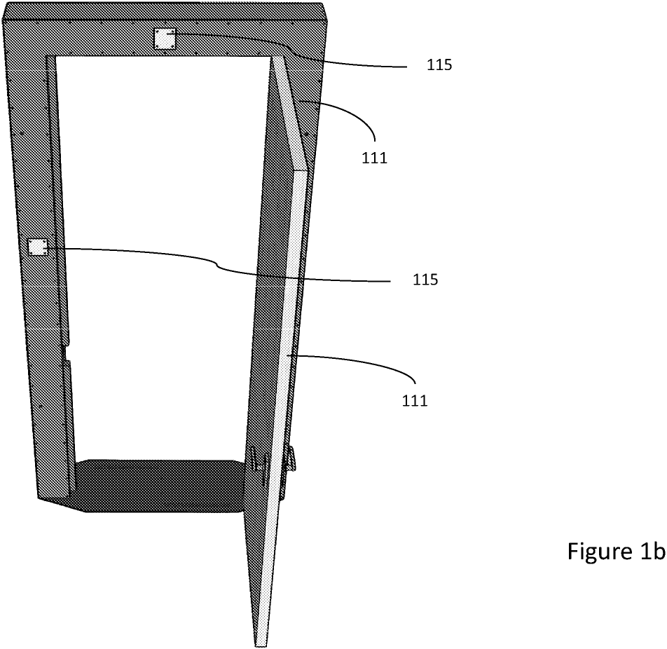

Referring firstly to FIG. 1, an installed facility 100 is illustrated. The facility comprises walls 101, in this embodiment arranged parallel to each other, and walls 102, in this embodiment parallel to each other and perpendicular to walls 102. Not all of the walls 101 and 102 are indicated in FIG. 1 by numerals for the sake of clarity. The walls 101 and 102 are interconnected by connectors, which in this embodiment comprise posts 103 positioned where the edge of one wall 101 meets another wall or the edge of another wall. The illustrated posts 103 extend along the entire height of the walls 101, 102 although this is not essential. Any other suitable connectors for interconnecting the walls may be used. Additional posts 103 or other suitable connectors may be provided for connecting walls 101 and 102 to exterior walls.

In general the walls 101, 102 may be arranged, using the connectors, in a first configuration to form at least two rooms, indicated as 105 in FIG. 1. The rooms 105 are rectangular as shown in FIG. 1 although other room shapes are possible. The term “rectangular” as used here is intended to include “square” unless otherwise stated. The walls 101, 102 may also be arranged, using the connectors, in at least one different configuration to form at least two rooms 105, for example of different sizes, as explained in more detail below. In principle the number of walls and connectors, and hence the number of rooms, included in a facility according to the invention has no upper limit, in practice this may be limited by the available space.

The facility shown in FIG. 1 also comprises a plurality of cameras 106, which may be arranged to view the floor area of all of the rooms 105. According to some embodiments the rooms, in which activity is to take place, may comprise the whole of the floor area of the facility. According to other embodiments the rooms may comprise part of the whole floor area.

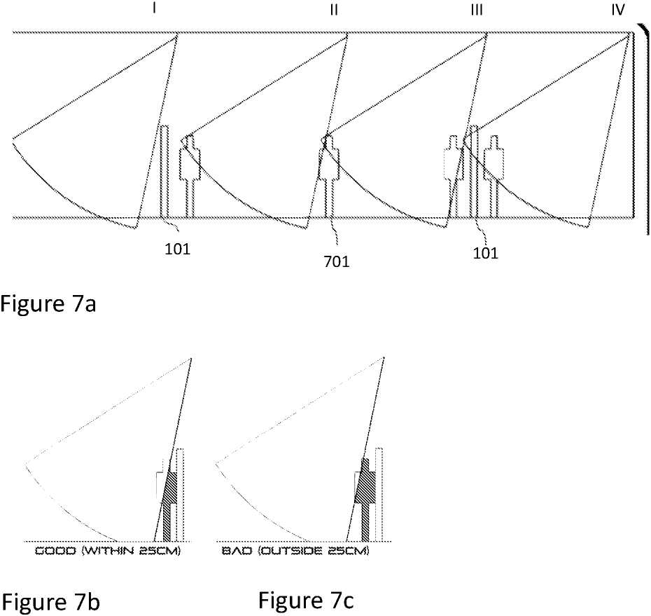

The plurality of cameras 106 may be arranged such that the whole of the floor area of the rooms 105 is visible by the cameras 106 in every configuration of the walls 101, 102. In other words, the cameras are arranged such that their fields of view cover the whole of the floor areas of the rooms. This avoids the need to move the cameras if the walls are moved. Better still, the camera positions may be sufficiently high that the walls are also visible to a predetermined height, up to their full height. In other words the cameras may be mounted such that a cone representing the field of view of the cameras intersects the walls at a predetermined height, rather than on the ground, as will be explained in more detail with reference to FIG. 7.

In order to achieve this, the cameras 106 are mounted above the height of the walls 101, 102. In this way, the cameras 106 may be arranged overhead, to provide a “top down” or aerial view of the floor area, also known as a bird’s eye view. The positioning of the cameras 106 above the height of the walls 101, 102 helps to ensure that the coverage of the floor space by the cameras 106 is not reduced, or minimally impacted when the walls are rearranged. In a kit for construction of a facility, the positions of the cameras may be predetermined rather than adjustable at the time of construction, in order to ensure the appropriate floor coverage. Similarly, in a kit the available positions of the walls may be limited, for example to a number of predetermined room configurations, for example to ensure that when the cameras are at their predetermined locations the floors of all of the rooms are visible in all their possible configurations. This may be achieved through the use of a user interface described further below which may “accept” or “reject” a proposed wall configuration.

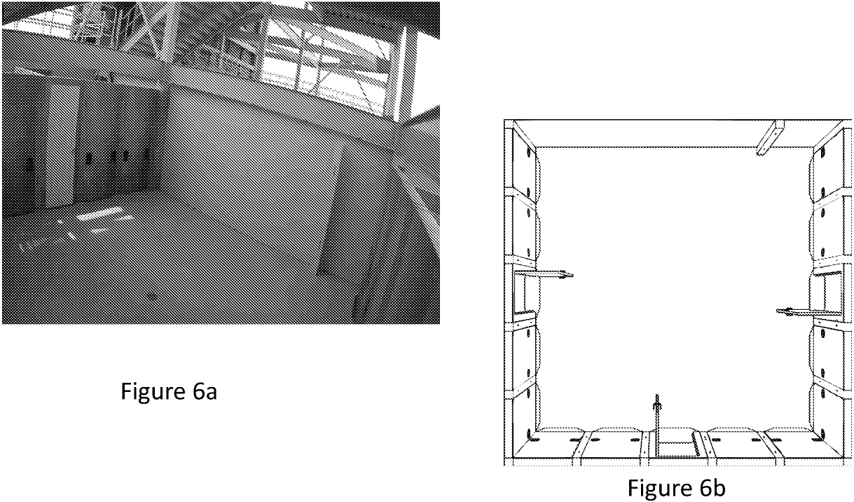

With typical domestic building wall heights, for example 2.1 metres, a suitable camera height is around 3.5 metres above ground level. The choice and arrangement of cameras is discussed in more detail with reference to FIGS. 6 to 9. PTZ adjustable cameras may be positioned at a height of 3.5 to 4.5 metres above the floor level which enables good coverage of rooms with walls constructed of 3 or 4 panels with a floor area of 3.39 m or 4.57 m x 3.39 m or 4.57 m.

A facility according to some embodiments of the invention may include a structure for supporting the cameras 106 and optionally other components described further below. In some embodiments this may comprise or be formed in the roof or the ceiling of the facility and thus a gap is present between the tops of the walls 101, 102 and the ceiling or roof in which the cameras 106 and optionally other components are mounted. In other embodiments, the support structure may comprise a frame 104 positioned above the height of the walls 101, 102. The cameras 106 may be attached to the frame or suspended from the frame or supported in any other suitable manner, for example at predetermined locations as noted above. The frame may be provided in a modular form and may be supported by the walls or on legs 107. The support structure, e.g. frame, may include channels for guiding cables to supply power to components mounted on it. Any suitable frame may be used, for example but not limited to an assembly of I-section metal beams. If the space in which the facility is provided has a ceiling or roof, the frame may be supported from the ceiling or roof. However the cameras are supported, according to some embodiments they may be arranged all at the same height above the floor of the facility, in other words the cameras may be mounted at a uniform height. Thus for example the support frame may be substantially flat. Most facilities will comprise an array of cameras, for example an arrangement of at least 2×2 cameras.

As noted elsewhere here the facility may be provided as a kit comprising the walls, the connectors, the cameras and the support structure, and optionally any one or more of the other components described here. In a kit, the positions of the cameras may be predetermined, for example to simplify installation, for example by providing camera mounts at fixed positions on frame components. Further, a kit may provide for predetermined wall positions that ensure the required coverage by the cameras at their predetermined positions.

It should be noted that the rooms 105 may be formed entirely from the walls 101 and 102, or one or more walls of any room may comprise an existing structure. For example, a facility according to some embodiments of the invention may be installed in an existing building and therefore a wall of the building, interior or exterior, may form a wall of a room of the facility. The facility described here, due to its reconfigurability, is equally suited to installation in an existing building or configuration to form a self-contained building.

It will be appreciated that walls 101, 102 as shown here form interior walls of the facility although they may also be used to form exterior walls. A kit according to some embodiments of the invention may comprise exterior walls which are of different construction from the exterior walls. One exterior wall 109 is indicated in FIG. 1. The exterior walls 109 may differ from the interior walls 101, 103 in any one or more of height, strength, size, thickness and other parameters. In contrast to the interior walls, the exterior walls may be designed to be assembled in only one configuration, for example rectangular.

A facility according to some embodiments of the invention may be provided with a monitor by which activity in the facility may be observed, either from within the facility of from an external location. The aspect ratio of the rectangular shape of the facility, e.g. the facility floor area, may be designed to match the aspect ratio of the monitor. For example the current standard for many monitors from tablet computing devices to large scale television screens is a 4:3 aspect ratio, and the floor area of the facility may be designed to have substantially the same aspect ratio.

As can be seen in FIG. 1, each wall may be formed from a plurality of interconnected panels. One such set of panels is indicated as 102a, 102b, 102c, 102d. This enables one or more walls to have an opening allowing passage from one room to another. Alternatively some panels or walls may have a cut-out for a door 110, optionally provided with a door frame.

The cameras 106 may be arranged such that no part of the floor area of the rooms is not within the field of view of one of the cameras, or at least such that any gaps in the coverage are not large enough for a subject being observed to hide in. In other words, the whole area may be observed and there is no place for a person to hide from the cameras. This may be achieved not only through suitable placement of the cameras, but also through design of the wall layout options to match the capabilities of the cameras being used. The cameras 106 and the available room configurations may be arranged such that the whole of the floor area of each room is within the field of view of one of the cameras. It is possible that more than one room is within the field of view of one camera. Alternatively a plurality of cameras with adjacent fields of view may be used to ensure that the whole area of a room is within the combined fields of view of a plurality of cameras.

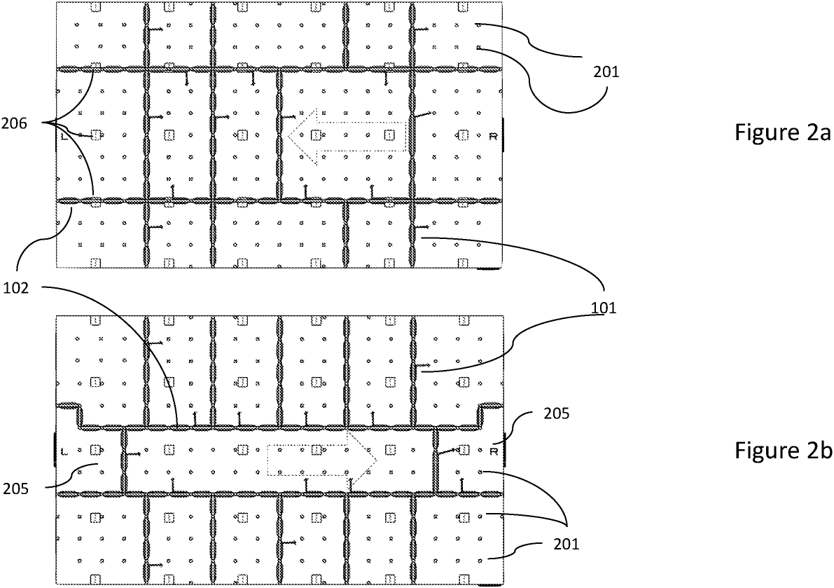

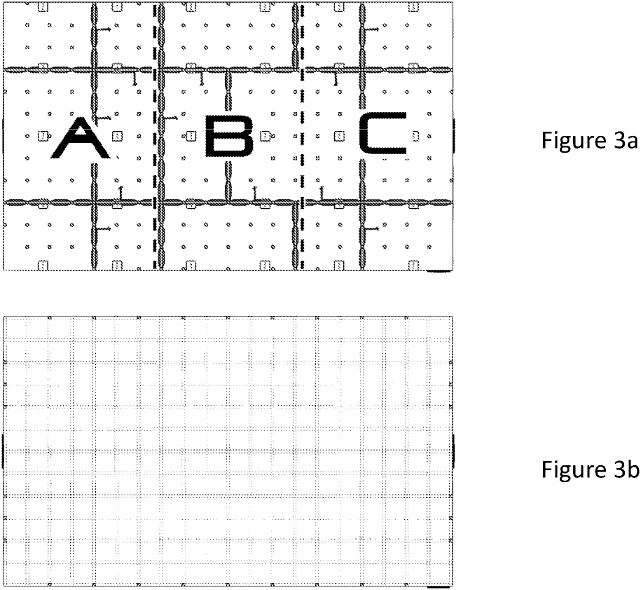

The design of the floor layout options according to some embodiments is illustrated in FIGS. 2a, 2b, 3a, 3b. According to some embodiments of the invention, the walls may be arranged in a rectangular grid. The kit may include one or more floor panels marked with possible positions for the walls and/or recesses or other locating means for receiving the walls and/or connectors. An example of this is shown FIGS. 2a and 2b where an array of dots 201 indicates possible positions for wall connectors, for example posts 103. In this example, each wall 101 or 102 comprises a plurality of panels and each panel has a width equal to the spacing between the connector positions 201. This enables a configuration as shown in FIG. 2b where one or more of the rooms, in this example two, 205 have a non-rectangular shape. In general the room configuration options allow the walls to be positioned to form a rectangular array of squares, as shown in FIG. 3b, optionally with the number of squares in each dimension matching the aspect ratio of a monitor provided for the facility. Usually each room will have an area corresponding to a plurality of the squares. Squares 206 in FIGS. 2a and 2b indicate positions of cameras 106. Here the cameras are equally spaced from each other. In the figures some cameras are mounted adjacent to the exterior walls but this is not essential. The cameras may be arranged to view a plurality of squares in the array, optionally with all cameras viewing an equal number of squares. An array of squares is convenient since only one size of wall panel is required but is not essential and any tessellating shape such as another rectangular shape may be provided for.

A facility according to some embodiments of the invention may comprise a lighting system. The lighting system may be mounted in the same way as the cameras, for example on the same support structure such as frame 104. The number of light sources may be the same as the number of cameras and their positioning may be similar. Alternatively fewer light sources than cameras may be required, for example one light source may be provided for every two or four cameras. The lighting system may comprise visible as well as infrared lighting. For example, for every visible light an infrared light may also be provided, as discussed further below. One light 108 is indicated in FIG. 1 mounted on frame 104.

According to some embodiments of the invention, the lighting system including some or all of lights 108 may be automatically and/or centrally controlled, for example by an observer of an activity taking place in the facility, e.g. using a monitor described further below. According to some embodiments it is desirable for some functions to be manually controllable by a user of the facility, in other words a person taking part in an activity in the facility, and therefore a switch system may be provided that is operable manually from within the facility to control one or more functions of the facility. One such function may be lighting. The one or more functions may be wirelessly operable. For example any of lights 108 may switched on or off via a wireless connection between a switch and the light.

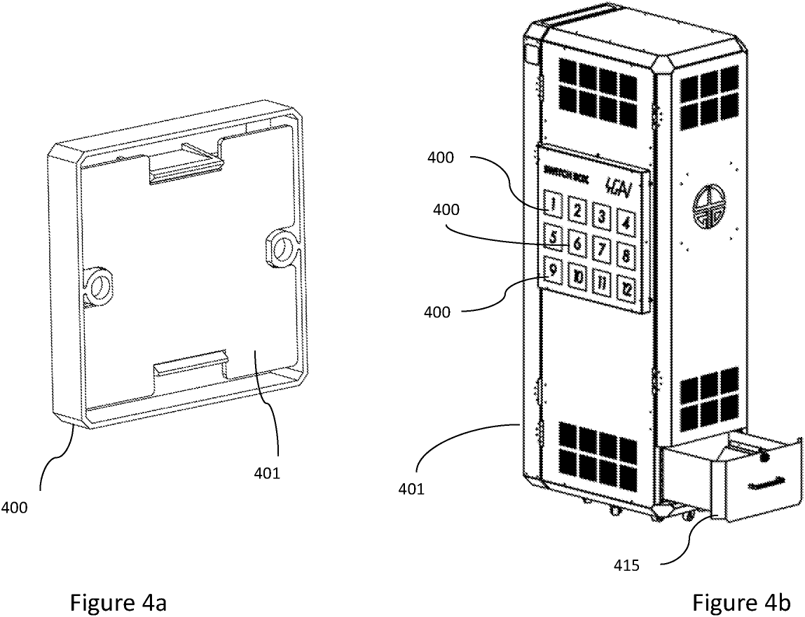

The switch system may comprise at least one switch mounted on one of the walls 101,102, for example a switch array which may be provided on a panel. The switch or switches may be removably mounted so that control of the lighting system may be reconfigured, either for a different exercise within an existing wall configuration or to produce a more suitable arrangement when the configuration of the walls is changed. Therefore some of the walls may be provided with a mount for one or more switches, for example either on the wall itself or on a frame provided in the wall such as a door or window frame. In some embodiments one or more mounts for switches or other control devices may be provided in a door frame 111. FIG. 1b shows a door 110 in frame 111 provided with two mounts 115 for receiving a control device. In general more mounts than control devices may be provided to facilitate the placement of the control devices in multiple configurations. In some embodiments, a wireless switch or switch array may be provided in which the switches are configured to wirelessly communicate with the function they are to control. A wireless arrangement is particularly useful since it avoids the need for any re-wiring with each reconfiguration, either of the switches or the walls. Any suitable mount may be provided. For military exercises, whether recreational or for training purposes, robustness is particularly important. For such purposes, or indeed any purpose, a magnetically mounted switch panel is particularly suitable. Such switch panels are commercially available and are typically used in situations where the installation of wiring is difficult. Here it is proposed that such switches may be used in situations where the wall or other location on which the switch is mounted is not fixed and therefore wiring is not desirable. One magnetically mountable switch panel 400 is illustrated in FIG. 4a and is provided with a rear magnetic plate 401. In this embodiment the mounts 115 may also comprise magnetic plates. Switch panel 400, or any other control device provided in a facility, may comprise a battery powered Wi-Fi operated device that may be configured to operate one or more lights or other functions.

A facility according to some embodiments may be provided with a plurality of switches or other control devices that are removably mountable in different places, magnetically or otherwise, and preconfigured to control one or more functions within the facility. Thus, wherever the control device is mounted the same function may be controlled by it. The functions may have fixed or predetermined locations within the facility. To take the example of lighting, infrared or visible, lights may be provided at predetermined locations and one or more switches may be configured, e.g. pre-programmed, to control one or more lights 108 at predetermined locations, for example a subset of the lights provided in the facility. This may be on a per zone basis so that a plurality of control devices is configured to control a function in a zone of the facility. The control devices may be mounted at different locations to enable the function to be controlled from different locations within the facility. Other functions within the facility may be similarly controlled.

The facility may be configured to form a series of zones, with a control device such as a switch or switch array being provided to control a function such as lighting for a whole zone. A zone may comprise for example an area served by a plurality of lights. FIG. 3a shows a simple arrangement in which a rectangular facility is divided into three adjacent zones A, B, C for which separate lights 108 may be provided. In a more complex arrangement, a zone need not be rectangular, and could comprise a set of areas that are not adjacent to each other. The same principles may be extended to functions other than lighting. In all cases a control device may be pre-configured to control one or more functions. This simplifies the initial setting up and reconfiguration of the facility.

A facility or kit according to some embodiments of the invention may be provided with a housing for computing equipment that may be provided to operate the facility. FIG. 4b shows an example of a housing 410. The housing 410 may contain the usual racking for electronics equipment as is known in the art. It may be designed to removably house one or more portable computing devices such as a laptop or tablet computer, and may comprise one or more docking stations or other suitable power connections so that a computing device battery may be charged when the device is housed in housing 410. According to some embodiments, a portable computing device may serve mainly to provide a user interface to other computing equipment and electronics used in the operation of the facility. Such computing equipment may be configured as one or more servers and/or comprise one or more processors and memory as described elsewhere here. It may respond to input via a portable computing device to configure the facility, for example operation of functions, according to input instructions. Sound effects, video information and other digital information useful in the operation of functions may be stored at the computing equipment. Thus according to some embodiments a facility may be “stand alone” and not for example require internet access or other remote connectivity. This is useful in ensuring security, for example of information which may be personal e.g. relating to a training activity, as well as facilitating implementation, i.e. getting the facility up and ready for use. In the housing 410 of FIG. 4b a drawer 415 is provided for this purpose. According to some embodiments, access to the contents of the housing 410 may be secured. For example identification may be required to open the housing such as but not limited to biometric fingerprint scanning, any of which identification equipment may be incorporated into the housing.

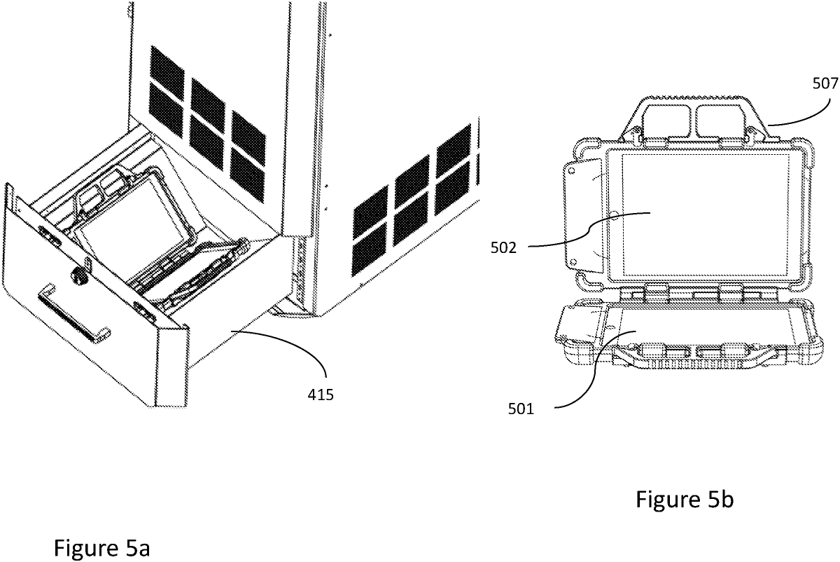

FIG. 5a shows the housing 410 with the drawer 415 pulled out. FIG. 5b shows a pair of tablet computing devices 501, 502 in a carry case 507, to be described further below, positioned in the drawer.

The housing 410 may conveniently accommodate a plurality of control devices such as the magnetically mountable switch 400 shown in FIG. 4a. Thus the housing 410 has a panel on one side to which twelve control devices are attached in rows of four and labelled and instructions may be provided indicating which control device controls which facility or facilities. It will be appreciated that any number of control devices may be provided, for example according to the size and complexity of the facility.

The choice and arrangement of cameras will now be described with reference to FIGS. 6 to 9. An important aspect of embodiments of the invention is the arrangement of the cameras to maximise the view of the floor area of the rooms of the facility and avoid the need for the cameras to be moved when the rooms of the facility are reconfigured. This is evident from FIGS. 6a and 6b, which show for comparison different views of rooms in a facility using respectively wall mounted and “top down” cameras. The view from the wall mounted camera shown in FIG. 6a does not show the whole of the floor area of the room being viewed, in particular the area directly beneath the camera. By contrast the view from a “top down” camera, i.e. a camera mounted above the height of the walls, shown schematically in FIG. 6b, includes the whole of the room floor area. FIG. 6b shows a room on the side of a facility including a thin fixed wall which is the wall of the facility.

The schematic view shown in 6b is an idealised view showing what might be achieved using a rectilinear lens, i.e. avoiding barrel distortion, and using a panoramic camera, so that the whole floor area is visible. However for some implementations of the facility some distortion such as barrel distortion may be acceptable. Also cameras with pan/tilt/zoom “PTZ” facility may also be used to achieve the desired coverage of the floor area and panoramic cameras are not essential. Further, a panoramic camera may have some facility for adjustment of pan, tilt or zoom. In the case of cameras with the facility to adjust one or more of pan, tilt or zoom, embodiments may provide for an adjustment between one room configuration and another, without the need to move the cameras from their mounting position, to achieve the required coverage. This may be achieved for example using a computer interface to input a selected room configuration, from which the appropriate adjustment may be determined using suitable software to output a control signal to one or more motors to make the adjustment automatically.

An embodiment using PZT cameras is illustrated schematically in FIGS. 7a, 7b, 7c. With a PZT camera that has a more limited viewing angle than a panoramic camera, it is important to consider also the desired height of coverage. FIG. 7a indicates cameras at positions I, II, III, IV positioned above walls 101 dividing an area into three rooms. The corresponding segments indicate the fields of view of the respective cameras. Shapes 701 are included to indicate people. It can be seen from FIG. 7a that if the cameras are not mounted at a sufficient height the heads of people may not always be visible. If any of the cameras was lowered, the head of a person at the left of a room would be “cut off”. To avoid this possibility, the cameras may be mounted at a sufficient height to view the top of objects up to a predetermined height, for example 2 or 2.1 m high.

It can be seen that with the arrangement of FIG. 7a there is a “blind spot” to the left of each wall 101. The cameras may be mounted such that this is not sufficiently large that a person will be invisible to the cameras. For example, the cameras may be mounted so that at least the top of an object 2 m high and 25 cm wide is visible at any position on the floor area.

FIGS. 7b and 7c show two views showing the difference in coverage that may be achieved by adjusting the tilt of a camera. In FIG. 7a the segment representing the camera field of view intersects the floor within 25 cm of the wall and is acceptable since the top of a person is visible. In FIG. 7b the tilt is rotated clockwise so that a larger part of the floor is outside the field of view and less of the person is visible. It will be appreciated that with PTZ cameras the ideal configuration may vary with different wall configurations and this may be adjusted automatically on reconfiguration of the facility in some embodiments.

According to some embodiments of the invention, where full coverage of the floor area is not possible, with an adjustable camera it may be possible to optimise the camera for the activity taking place in the facility. For example, if the expected direction of travel of personnel in the facility is to the left as shown in FIGS. 7a, 7b, 7c, the blind spot to the left of the walls 101 may be acceptable, but for another kind of activity it may not in which case the camera PZT may be adjusted. For example, the cameras may be arranged, e.g. PTZ adjusted for a “right to left” scenario in which travel of subjects is from left to right on a viewing monitor, and the cameras could be adjusted for a different direction of travel e.g. from top to bottom by rotating them by 90 degrees.

This adjustment of a PZT camera may be carried out automatically, e.g. for a different configuration of walls or different activity, as will be described further below.

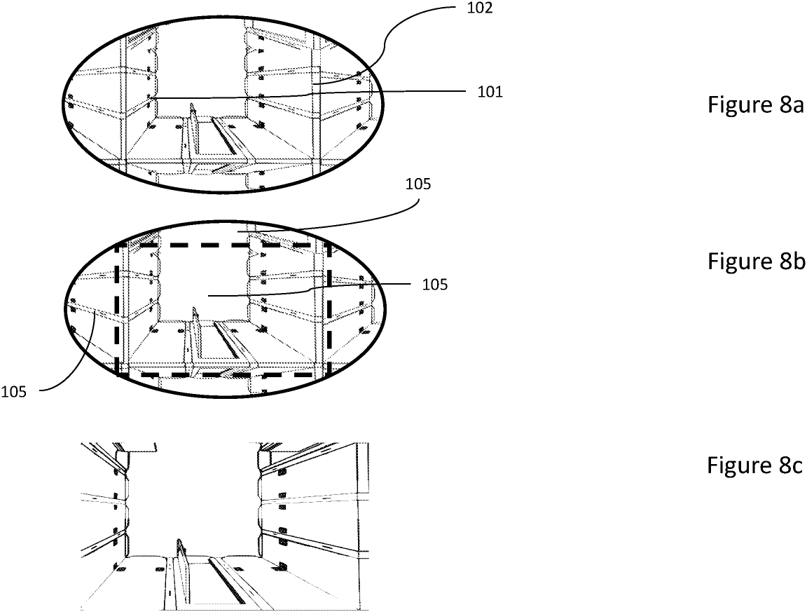

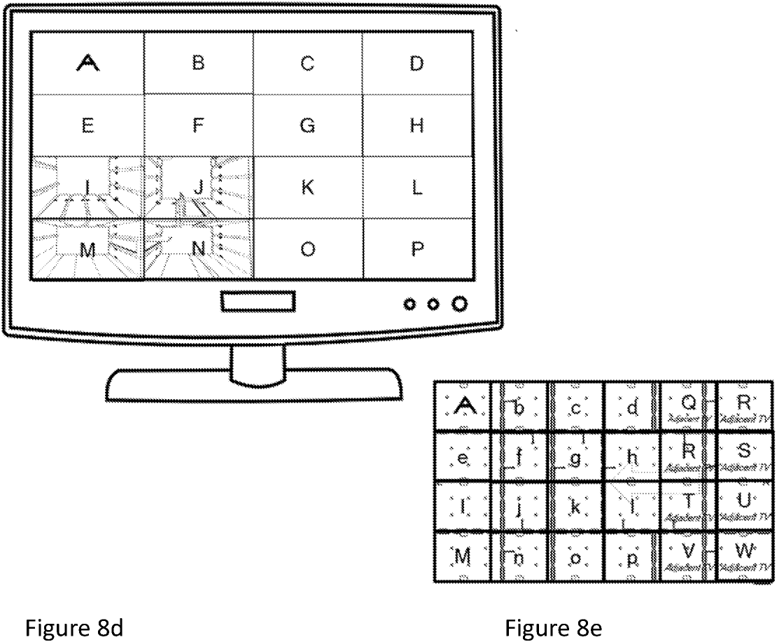

It will be appreciated that the cameras 106 may generate a stream of video footage that may be viewed in real time and/or stored in memory for example for later analysis. According to some embodiments of the invention, the camera images may be generated so that the images from respective cameras represent a set of substantially contiguous areas of the floor of the facility. The images may then be presented on a monitor as a set of rectangles or “tiles” representing different floor areas to provide as near as possible an aerial view of the facility, with no gaps and no overlaps between adjacent areas. This is explained in more detail with reference to FIGS. 8a-8d using panoramic cameras as an example but the same principle is applicable to other kinds of camera.

FIG. 8a shows a typical elliptical image from a panoramic camera positioned above a configuration of walls 101, 102. Part of one room is in the centre of the field of view with the surfaces of three of its walls visible. Parts of adjacent rooms 105 are also visible but in each case the shadow of the walls of the centre room obscures the view of the floor. Therefore this camera as positioned may be used for observation of the centre room and other cameras may be used for observing the adjacent rooms. To avoid presenting overlapping areas on a monitor, which may be confusing to the viewer, the image from the camera may be cropped as indicated in FIG. 8b. The cropped image is shown in FIG. 8c. A set of similarly cropped images from different cameras may be presented in an arrangement corresponding to the facility floor plan, in the manner of adjacent “tiles” with the respective images showing contiguous rectangular areas of the floor. This cropping is not limited to panoramic cameras and may be applied to any other kind of camera that may be used. The cropping may be achieved by suitable configuration of the cameras and/or monitor. It will be appreciated that the monitor may comprise or be controlled by a computing device. As noted elsewhere the aspect ratio of the facility floor and hence the set of cropped images may correspond to the aspect ratio of a monitor with which activity within the facility is to be viewed. Some of the images may show parts of walls of rooms as shown in FIGS. 8a-8c but the images may be presented such that there are no overlaps or gaps between the floor areas viewed by the cameras. This is indicated schematically in FIG. 8d in which two “tiles” I, J, M, N include images and the positions of additional tiles A-P are indicated as rectangles. The spatial arrangement of the images corresponds to the spatial arrangement of the corresponding areas of the facility floor viewed in the images. According to some embodiments, the aspect ratio of the floor of the facility may correspond to the aspect ratio of the monitor. In other words tiles or images A-P in FIG. 8d may correspond to the whole of the floor area of the facility. Additionally the aspect ratio of each image, or “tile” may correspond to the aspect ratio of the monitor and/or facility floor area. However this is not necessary and each tile may have a different aspect ratio, e.g. square. Alternatively, by presenting the spatial arrangement of the images in a manner corresponding to the spatial arrangement of the floor, the remainder of the floor area may be presented so as to be visible for example by swiping left/right or up/down. This is shown schematically in FIG. 8e where the remainder of the floor area to the right, on tiles labelled Q-W, may be brought into view by a suitable swipe on a touch screen or action on any kind of user interface as is known in the art. In some embodiments, the floor area of the facility may be designed to have an aspect ratio that is an integral multiple of the aspect ratio of the monitor, for example so that the whole of the floor area is visible on a multiple of monitors, preferably with the monitors in the same spatial arrangement as the facility floor. Thus one monitor may show images 1-16 and a second monitor may show images 17-32.

It can be seen from a comparison of FIGS. 8a and 8b that a substantial amount of captured image data is cropped and not required. A number of ways of cropping the images will be familiar to those skilled in the art, some of which involve presenting to the viewer a subset of available image data. Thus “cropping” as it is usually carried out involves discarding or ignoring captured data. This discarded or captured data may nevertheless be stored for future use or to permit adjustments in how the cropping is carried out.

According to some embodiments of the invention, only this subset of available image data is stored. This results in a large saving of data to be stored and processed. A further saving in data storage and processing may be achieved according to some embodiments of the invention in which the image data that is not required is not captured by the cameras 106. In other words, rather than cropping the images, the cameras 106 may be configured, through the use of suitable algorithms, to capture and transmit only the image corresponding to a subset of the camera field of view, for example a rectangular area within the camera field of view. The cameras may then be arranged in the facility such that the subsets correspond to substantially contiguous areas on the facility floor. For a typical camera the subset will correspond to a subset of pixels from which image data is available.

It should be noted here that according to some embodiments of the invention the facility may be self-contained and not require the use of external communications. According to other embodiments, some data may be transmitted outside the facility for later analysis, for example a limited amount. Additionally or alternatively the amount of data that can be transmitted or exported outside the facility may be limited by use of suitable security measures, and/or restriction to certain storage devices, such as pre-configured storage devices such as memory, e.g. USB memory.

A facility according to some embodiments of the invention may include one or more sensors to detect actions by personnel using the facility. The detection of actions may be used for example in simulating an environment within the facility. It should be noted that embodiments of the invention are not limited to any particular kind of simulation and may include for example military and civilian environments for training or recreational purposes.

The detection may trigger a function within the facility. Examples of sensors include but are not limited to movement sensors, which may be mounted on one or more of the walls 101, 102, sensors of light or other electromagnetic radiation that may be generated from a device used by a user performing an activity in the facility, and others. In some embodiments, sensors may be provided in structures that are not fixed with respect to the walls, e.g. free standing, for example intended for users to interact with them, one example being a target that may be placed in any position in a room.

Functions that might be triggered in response to sensing include but are not limited to:
lighting, for example illumination of a room or zone on entry or lighting effects such as strobe lighting;
imagery including for example display of scenery, for example onto walls on entry into a room, or generation of holographic images including 3D images, for which the facility may include projection equipment;
effects such as explosions or smoke, for which the facility may include one or more smoke machines or explosive devices; release of aromas, for which one or more aroma sources may be provided;
audio effects for which one or more speakers may be provided, including effects such as shouting, gunfire, screaming or other, that may for example prompt a particular reaction by personnel using the facility, and/or background or passive audio effects such as ambient noises that might be appropriate to an environment being simulated, e.g. jungle sounds, city street noises and others; and
appearance or movement of a target which may be mechanical or computer generated.

Any of these effects may be triggered in any way, for example in response to movement by personnel or interaction with any part of the facility or effects produced in the facility.

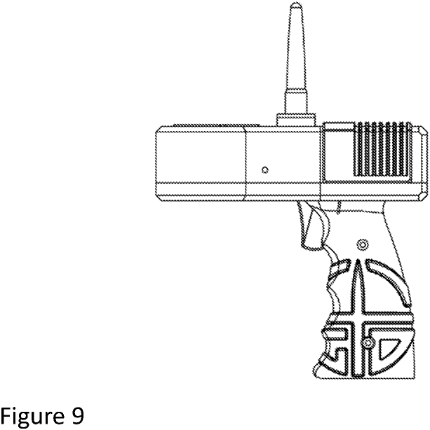

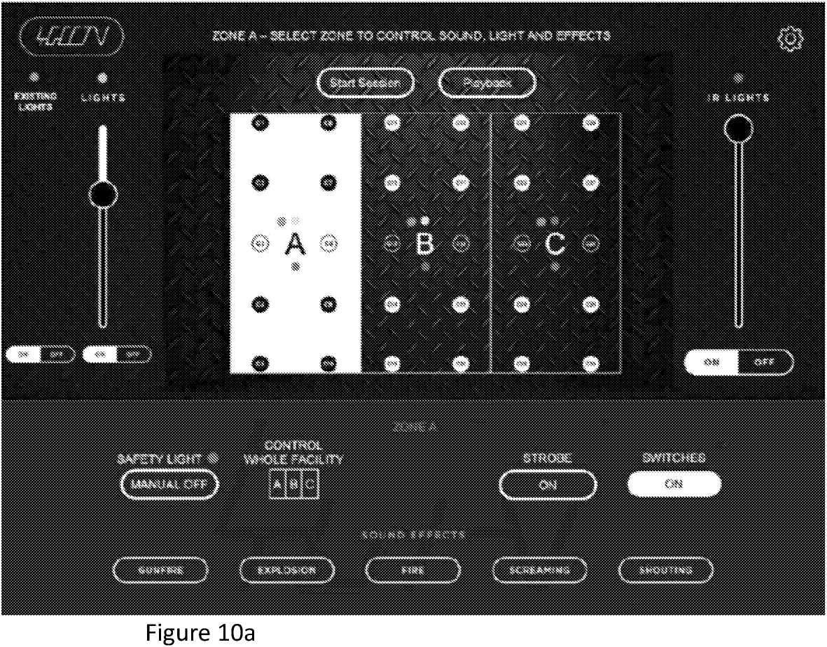

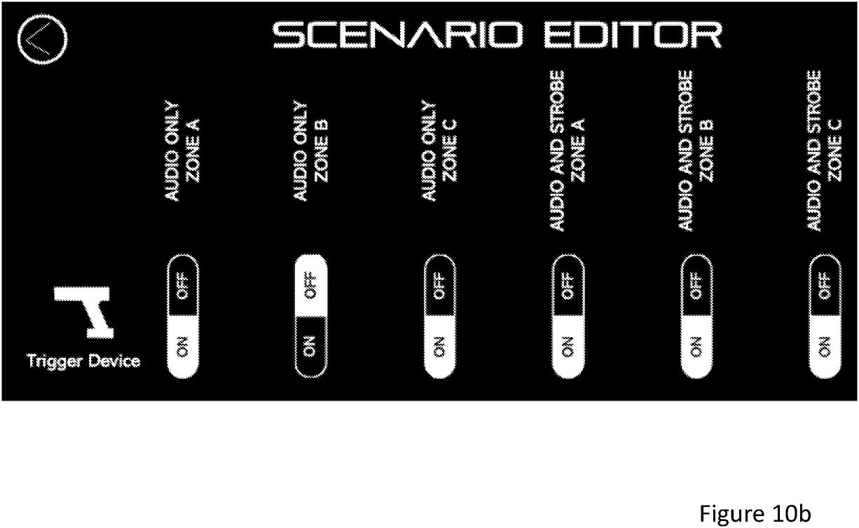

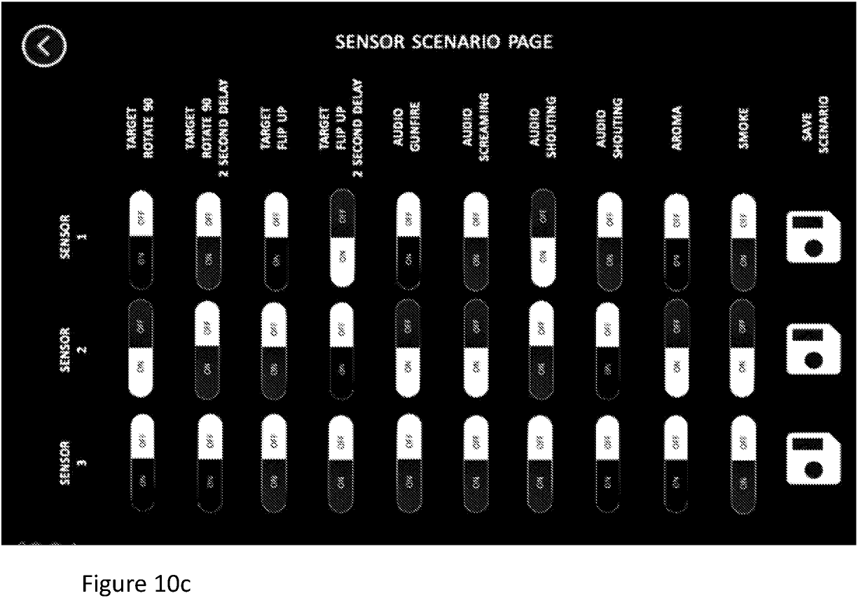

According to some embodiments, any one or more of the functions of the facility may be triggered by one or more trigger devices configured to provide a trigger signal. One example of a trigger device is shown in FIG. 9 in the form of an IED (improvised explosive device) trigger. Any appropriate function may be triggered, e.g. switched on, in response to the operation of a trigger device. Trigger devices may take many forms, for example appropriate to the activity to be performed in the facility. For the simulation of military activities other examples include grenades and other weapons. The trigger signal may take any form including but not limited to a laser beam detected by a sensor, a short range rf signal detected by a computing device in the facility or any other form. Conveniently the trigger device may operate using the same technology as the wireless switch described above in relation to lighting control.

It will be appreciated from the foregoing that a facility may include a wide range of functions each of which may be operated by any of control devices, sensor signals and trigger device signals as described here. An operator configuring a facility may choose any permutation of function and operation. If a large number of permutations is available it is advantageous for this to be simplified by predetermining the locations of any of the functions and configuring any of the control devices, sensors or trigger devices to operate on a zone basis. Thus for example a control device, sensor or trigger may then operate a function or every instance of that function for the whole of a zone.

It should be noted that operation of functions is not limited to simple ON/OFF. For example some functions such as lighting, sound and others may be controllable in terms of amplitude from any of control devices, sensor signals and trigger devices.

For activities intended to simulate night time environments the use of dimmable infrared lighting may be provided, for example to enable the IR amplitude to vary according to the conditions and/or level of experience of a participant in an activity. Dimmable IR might be useful for example where a user is provided with an IT torch or where night vision headsets are provided to users which operate best with a small amount of natural light.

Whilst some or all functions of the facility may be manually operable, or operated automatically for example in response to sensor or trigger signals, a facility according to some embodiments of the invention may include functions that may be controlled from outside or inside the facility, for example from a computing device such as a laptop or tablet. Any of the aforementioned functions may be controlled in this way. The functions may be controlled from a computing device, e.g. wirelessly. The same or a different computing device may be used in the configuration of the facility as explained further below.

FIGS. 10a, b, c show examples of a user interfaces that might be presented to a user of a computing device to control one or more functions of the facility.

In the example of FIG. 10a, a number of functions are controllable for each of three zones A, B, C, such as those shown in FIG. 3a, or for the whole facility, according to which option is chosen. The functions shown in FIG. 10a comprise different kinds of lighting including visible and infrared and sound effects such as gunfire, explosions, fire, screaming and shouting. Other functions may be provided as also described elsewhere here. For example explosions and fires may be real or simulated.

Functions of the facility may be controlled as activity in the facility is observed or as mentioned elsewhere here they may be controlled automatically, for example in response to sensor or trigger signals. Thus the interface shown in FIG. 10a may be used to configure the automatic operation of functions so that after configuration no further control of some or all functions is required as an activity within the facility takes place.

FIG. 10b shows an alternative user interface that may be used in the configuration of a facility according to some embodiments of the invention, in which one or more functions may be configured on a per-zone basis, in this example audio and strobe effects. Any permutation of zones and functions may be provided for in the user interface. According to some embodiments of the invention, where there are a large number of functions and zones, a number of preconfigured combinations of zones and functions may be provided.

FIG. 10c shows a user interface that enables the configuration of one or more functions to operate in response to sensor signals. Similarly one or more functions may be configured to operate in response to one or more trigger signals. In the example of FIG. 10c, the functions include various operations that may be performed by a target, audio effects such as gunfire, screaming or shouting, release of an aroma and release of smoke. Different configurations may be set and saved for future use with a “save scenario” option, for example on a per sensor basis. It will be noted that in this example a target is provided which may flip up or “appear” or perform rotational movements, either immediately or after a 2 second delay. These are appropriate for a mechanical target but it will be appreciated that other movement options or activities of targets may be configured and any of these may be performed with mechanical or computer generated, e.g. projected or holographic, targets.

Functions may be controlled and activity monitored conveniently using a pair of touch screens, for example a pair of tablet computing devices. FIG. 5b shows a pair of tablet computing devices 501, 502, in this case both the same kind of device, for example iPad, provided in a dedicated case 507 optionally toughened for the environment. One device e.g. 501 may be configured to present a user interface, for example as shown in FIGS. 10a, b, c. The other 502 may be configured as a monitor and may be used to display footage from cameras viewing contiguous areas on the floor of the facility similar to those shown in FIG. 8d. The two devices 501 502 may communicate with each other, for example so that a touch screen presenting a user interface may be used to control what is presented to the user in the other touch screen as an alternative to touching the display screen or to control what is displayed in any other way.

The top down view of the rooms lends itself to a more intuitive presentation for anyone observing activity within the facility from the camera feeds, either as the activity takes place or at a later time. Unlike conventional CCTV displays, where the cameras may view different areas from different angles, such as shown in FIG. 6a, the activity may be observed as a plan or aerial view, by presenting the camera feeds in the same spatial arrangement as the cameras. This is visible in FIG. 8d for example where the camera feeds are presented in a side-by-side arrangement corresponding to the spatial relationship of the cameras or the respective areas viewed by the cameras, for example replicating the facility floor plan. In FIG. 8d the camera feeds show the whole of the floor of the facility. In some embodiments, a user would be able to “move” from one area to another, or one camera view to another, in the same manner as, for example, moving over Google earth, for example using a touch screen device.

It will be appreciated that a facility according to embodiments of the invention may be provided with either a dedicated computing device or an application, to be installed on a computing device, for controlling the facility e.g. as illustrated in FIGS. 10a, b, c and/or viewing activity taking place in the facility e.g. as illustrated in FIG. 8d.

A facility according to some embodiments may be supplied as a kit, to be installed in a chosen configuration, and it may be provided with an application “app” to facilitate the installation and/or facilitate control of the facility such as the functions described above when the facility is in use.

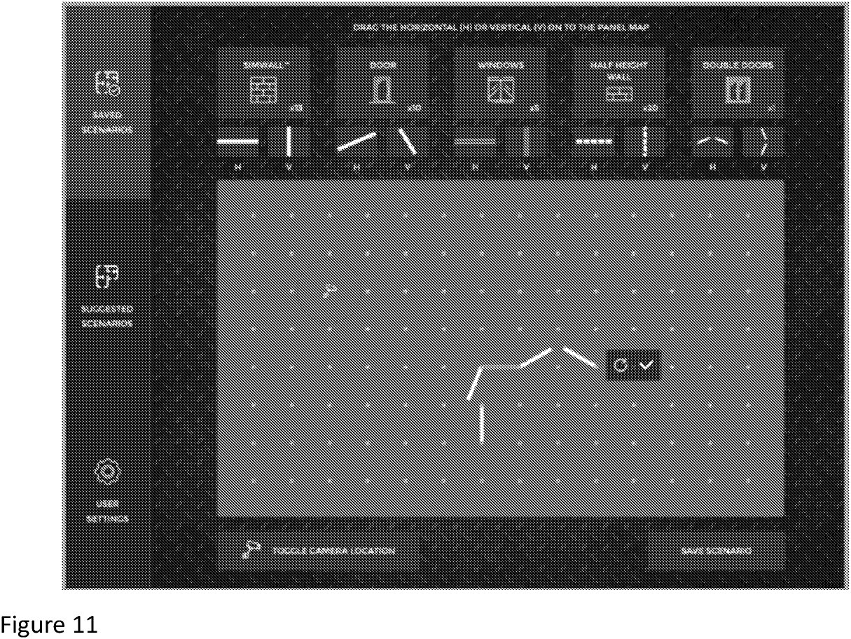

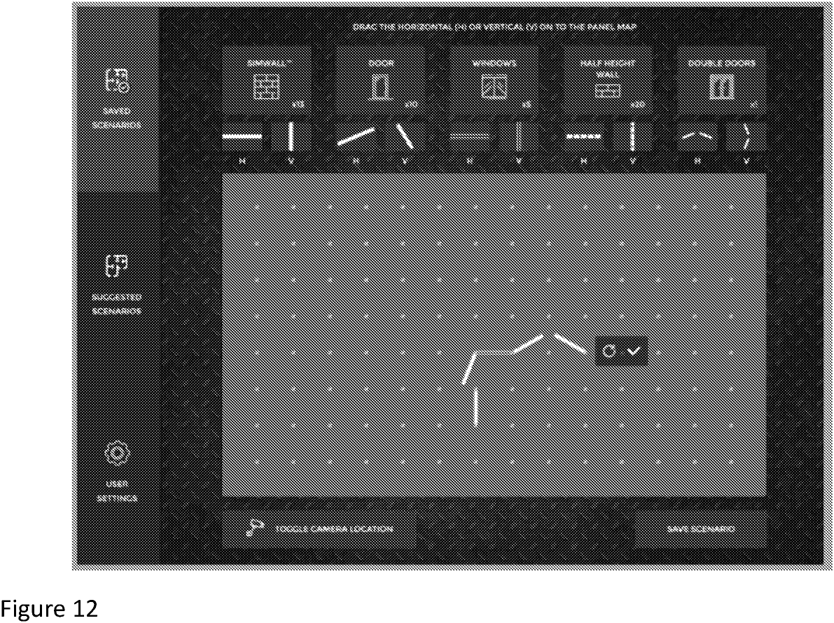

FIGS. 11 and 12 are examples of user interfaces that might be provided as part of an installation app, to illustrate the way in which an installer might be aided in the installation of a facility according to some embodiments of the invention.

The installer may be using a kit with a predetermined number of components or may have selected the number of components. The components are represented at the top of the screen showing the quantity and type of each one available for the installation. The user of the app may drag and drop components such as walls, doors and windows onto a representation of the facility floor plan and for example test door openings to avoid collisions similar to architectural design apps. Each configuration is termed a “scenario”, which may be saved for future use, and some predetermined scenarios may be provided.

FIG. 11 includes a “toggle camera” option which when selected shows the complete set of images from all of the cameras whereby the coverage of the cameras can be checked, for example a view similar to FIG. 8d. As noted elsewhere the facility may be preconfigured to enable only wall configurations in which the required coverage is satisfied. This may be achieved mechanically to limit the available options for positioning of the walls, or through the use of computer software, or a combination of these. In the embodiment shown in FIG. 11 only certain wall configurations are permitted. By showing the camera images to the user, the user is guided as to how to rearrange the walls to provide a permissible configuration.

FIG. 12 shows with the use of a tick icon that a permissible wall configuration has been selected. Thus the app implemented in the computing device limits the available wall configurations.

The user interface may be used in the automatic adjustment of a PZT camera as mentioned earlier. For example, the camera may be adjusted automatically in response to the user inputting the wall configuration or a new wall configuration. Similarly the user may be able to input an intended direction of travel for an activity so that the cameras may be positioned in order to avoid missing any activity.

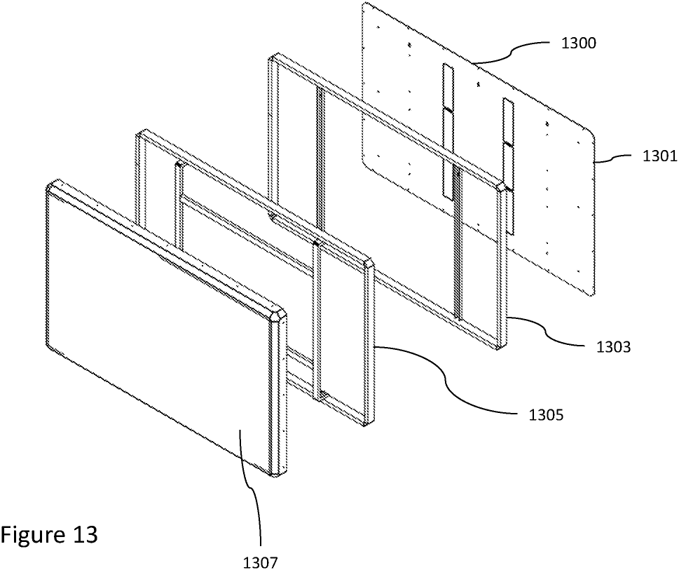

A facility according to some embodiments of the invention may include a dedicated control room from which activity in other rooms of the facility may be observed and from which one or more functions may be controlled in the case of an activity for which functions are not fully preconfigured. Alternatively the facility may be designed such that one room may be used for post-activity viewing on a large screen, for example by providing a large screen protected by a protective cover so that it is invisible to users of the facility during an activity and is robust so as not to be damaged by the activity. FIG. 13 shows a screen mounting assembly 1300 comprising in this example a screen wall panel 1301 to be mounted on a room wall, a wall frame 1303 to be mounted on a wall surrounding the screen wall panel 1301, a lid frame 1305 which may for example be connected to the wall frame 1303, and a lid panel 1307 fixed to the lid frame 1305 to protect a screen housed in the assembly.

Any of the computing systems described herein may be combined in a single computing system with multiple functions. Similarly the functions of any of the computing systems described herein may be distributed across multiple computing systems.

Some operations of the methods described herein may be performed by software in machine readable form e.g. in the form of a computer program comprising computer program code. Thus some aspects of the invention provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The embodiments described above are largely automated. In some examples a user or operator of the system may manually instruct some steps of the method to be carried out.

In the described embodiments of the invention the system may be implemented as any form of a computing and/or electronic system as noted elsewhere herein. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The term “computing system” is used herein to refer to any device with processing capability such that it can execute instructions. Those skilled in the art will realise that such processing capabilities may be incorporated into many different devices and therefore the term “computing system” includes PCs, servers, smart mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method steps or elements identified, but that such steps or elements do not comprise an exclusive list and a method or apparatus may contain additional steps or elements.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A facility for use in providing a simulated environment comprising a plurality of walls and a plurality of connectors for interconnecting the walls in at least two different configurations to form at least two rooms, a plurality of cameras, and a support structure configured to support the plurality of cameras above the height of the walls.

2. The facility of claim 1 wherein the plurality of cameras are arranged such that a floor area of all the at least two rooms is visible by the plurality of cameras in the at least two different configurations.

3. The facility of claim 2 wherein the camera positions are sufficiently high that the walls are also visible to a predetermined height.

4. The facility of claim 1, wherein the plurality of cameras comprises an array of at least 2x2 cameras.

5. The facility of claim 1, wherein the plurality of cameras are arranged at a uniform height above a floor of the facility.

6. The facility of claim 1 wherein the walls are configurable in a rectangular grid arrangement and each camera of the plurality of cameras is arranged to view a plurality of squares within the grid.

7. A kit of parts for constructing a facility as claimed in claim 1.

8. (canceled)

9. The facility of claim 1, further comprising one or more floor panels marked with possible positions for the walls and/or recesses or other locating means for receiving the walls and/or connectors.

10. The facility of claim 1, wherein the facility has a rectangular floor area, comprising a monitor by which activity in the facility may be observed in which the aspect ratio of the rectangular floor area matches the aspect ratio of the monitor.

11. The facility of claim 10, configured to crop the images from the plurality of cameras to respective contiguous areas of the rectangular floor area of the facility and to display on the monitor a set of similarly cropped images from different cameras in an arrangement corresponding to a floor plan of the facility.

12. The facility of claim 1 further comprising a lighting system, wherein the support structure is configured also to support the lighting system.

13. The facility of claim 1, comprising a plurality of control devices operable manually from within the facility to wirelessly control one or more functions of the facility and wherein the plurality of control devices are configured to be removable mountable at a plurality of different locations in the facility.

14. (canceled)

15. (canceled)

16. The facility of claim 1, comprising one or more sensors or trigger devices wherein one or more functions of the facility is operable is operable in response to a signal from a sensor or trigger device.

17. (canceled)

18. (canceled)

19. The facility of claim 1 configured to provide one or more functions being any one or more of:
lighting,
imagery,
explosion,
smoke generation,
aroma generation,
sound,
appearance or movement of a target.

20. The facility of claim 1 wherein the plurality of cameras are configured to capture and transmit only the image data from a subset of pixels corresponding to a rectangular area within a field of view of a camera of the plurality of cameras.

21. The facility of claim 19 wherein the plurality of cameras are arranged in the facility such that the subsets of pixels correspond to substantially contiguous areas on the facility floor.

22. The facility of claim 1, wherein the plurality of cameras are configured to adjust one or more of pan, tilt and zoom, and are mounted so as to be adjustable between one room configuration and another to achieve a required visibility of floor area, without the need to move the plurality of cameras from their mounting position.

23. The facility of claim 1, comprising a computer readable medium, wherein the computer readable medium comprises instructions which when implemented in a computing device enable the computing device to configure one or more functions of the facility and/or verify that a wall configuration satisfies a camera visibility requirement.

24. The facility of claim 23, wherein the computing device implementing the instructions is configured to receive information relating to an activity to be performed in the facility and/or to the configuration of the walls and to determine an adjustment any of pan, tilt and zoom of at least one of the plurality of cameras according to the activity and/or the configuration.

25. The facility of claim 23,wherein the computing device implementing the instructions is configured to present a user interface to receive user input to determine which signals from any of a control device, a trigger device or a sensor cause the operation of one or more functions of the facility.
